(19) United States
(12) Patent Application Publication
(10) Pub. No.: US 2024/0172589 A1
(43) Pub. Date: May 30, 2024

(54) Methods of Detecting Foreign Objects in Crop Material, and Related Harvesting Machines

(71) Applicant: AGCO Corporation, Duluth, GA (US)

(72) Inventor: Friedrich Robert Honeyman, Hesston, KS (US)

(21) Appl. No.: 18/551,722

(22) PCT Filed: Feb. 14, 2022
(86) PCT No.: PCT/IB2022/051292

§ 371 Date: Sep. 21, 2023

Related U.S. Application Data
(60) Provisional application No. 63/167,217, filed on Mar. 29, 2021.

(51) Int. Cl. A01D 41/127; A01D 41/14; G01N 22/00

(52) U.S. Cl. CPC A01D 41/127; A01D 41/14; G01N 22/00

(57) ABSTRACT

A method of detecting foreign objects in crop material includes transferring a cut crop material through a sensing area. Electrodes are arranged around a periphery of the sensing area. A first electromagnetic field is generated by broadcasting first electromagnetic radiation from a first electrode into the sensing area. A first attribute related to the first electromagnetic field is measured at some of the electrodes. A second electromagnetic field is generated by broadcasting second electromagnetic radiation from a second electrode into the sensing area. A second attribute related to the second electromagnetic field is measured at some of the electrodes. The first and second attributes are correlated to a property of a material in the sensing area, and thus, foreign objects may be detected in crop material. Related systems are also disclosed.

### CROSS-REFERENCE TO RELATED APPLICATION

This application claims the benefit of the filing date of U.S. Provisional Patent Application 63/167,217, “Methods of Detecting Foreign Objects in Crop Material, and Related Harvesting Machines,” filed Mar. 29, 2021, the entire disclosure of which is incorporated herein by reference.

### FIELD

Embodiments of the present disclosure relate generally to harvesting crops, and particularly to methods of detecting objects during a harvest, and related systems.

### BACKGROUND

Forage harvesters are used to harvest different kinds of crops which may require different harvesting processes. For example, a forage harvester may cut grass from a field, compress the grass in the compression rollers, and chop the harvested material into smaller parts in a chopper drum. The chopped grass is then discharged by a blower via a spout into a trailer. Harvesting a kernel crop such as maize may additionally include cracking the closed skin of the kernels.

Cracker units typically include two longitudinal cracker rollers arranged with a roller gap (longitudinal space) between them through which harvested crop is fed. As shown in European Patent 2 595 468 B1, “Cracker Roller Assembly,” granted Apr. 6, 2016, the cracker rollers may each be formed by an arrangement of multiple cracker roller discs mounted on a common shaft. Each disc typically has an arrangement of radial cutting surfaces across each face to assist in breaking up the material. The discs of one cracker roller may rotate within spaces between discs of the other cracker roller. Cracker roller discs are also discussed in U.S. Patent Application Publication US 2013/0316771 A1, “Cracker Roller Disc,” published Nov. 28, 2013.

Due to the relatively small distance between the cracker rollers and discs thereof that enable the cracker rollers to crack kernels, forage harvesters are subject to damage from foreign objects in the crop stream. For example, a rock picked up by the header of the forage harvester and transferred to the cracker rollers may break one or both of the cracker rollers. Furthermore, a forage harvester can be damaged by metal objects within the crop stream.

Combine harvesters may likewise be damaged by rocks and other foreign objects in a crop stream. Combine harvesters may include a rock trap to mitigate the risk of damage from rocks, as described in International Patent Publication WO 2015/028854 A1, “Combine with Actuator Controlled Rock Trap,” published Mar. 5, 2015.

### BRIEF SUMMARY

Some embodiments include a method of detecting foreign objects in crop material. The methods include transferring a cut crop material through a sensing area. A plurality of electrodes are arranged around a periphery of the sensing area. A first electromagnetic field is generated by broadcasting first electromagnetic radiation from a first electrode of the plurality into the sensing area. A first attribute related to the first electromagnetic field is measured at some of the plurality of electrodes. A second electromagnetic field is generated by broadcasting second electromagnetic radiation from a second electrode of the plurality into the sensing area. A second attribute related to the second electromagnetic field is measured at some of the plurality of electrodes. The first and second attributes are correlated to a property of a material in the sensing area.

In some embodiments, a harvesting header includes at least one cutting tool, a header frame carrying the at least one cutting tool, and a controller. The header frame is configured to transport cut crop material from the at least one cutting tool through a sensing area to a machine carrying the harvesting header. A plurality of electrodes are arranged around a periphery of the sensing area. The controller is configured to cause individual electrodes of the plurality to generate electromagnetic fields by broadcasting electromagnetic radiation into the sensing area and measure an attribute related to the electromagnetic fields at some of the plurality of electrodes.

In certain embodiments, an agricultural machine includes a frame configured to transport cut crop material from at least one cutting tool through a sensing area to a crop-processing device, a plurality of electrodes arranged around a periphery of the sensing area, and a controller. The controller is configured to cause individual electrodes of the plurality to generate electromagnetic fields by broadcasting electromagnetic radiation into the sensing area, and measure an attribute related to the electromagnetic fields at some of the plurality of electrodes.

### BRIEF DESCRIPTION OF THE DRAWINGS

While the specification concludes with claims particularly pointing out and distinctly claiming what are regarded as embodiments of the present disclosure, various features and advantages of embodiments of the disclosure may be more readily ascertained from the following description of example embodiments of the disclosure when read in conjunction with the accompanying drawings, in which:

FIG. 1 is a simplified side view illustrating a forage harvester carrying a harvesting header with a sensor array;

FIG. 2 is a simplified schematic view of a sensor array that may be used by the forage harvester shown in FIG. 1, in which one electrode is broadcasting electromagnetic radiation;

FIG. 3 is a simplified schematic view of the sensor array of FIG. 2, in which a different electrode is broadcasting electromagnetic radiation; and

FIG. 4 illustrates an example computer-readable storage medium comprising processor-executable instructions configured to operate the sensor array of FIG. 2.

### DETAILED DESCRIPTION

The illustrations presented herein are not actual views of any particular harvester or sensor, but are merely idealized representations that are employed to describe example embodiments of the present disclosure. Additionally, elements common between figures may retain the same numerical designation.

The following description provides specific details of embodiments. However, a person of ordinary skill in the art will understand that the embodiments of the disclosure may be practiced without employing many such specific details. Indeed, the embodiments of the disclosure may be practiced in conjunction with conventional techniques employed in the industry. In addition, the description provided below does not include all elements to form a complete structure or assembly. Only those process acts and structures necessary to understand the embodiments of the disclosure are described in detail below. Additional conventional acts and structures may be used. Also note, the drawings accompanying the application are for illustrative purposes only, and are thus not drawn to scale.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof.

As used herein, the term “may” with respect to a material, structure, feature, or method act indicates that such is contemplated for use in implementation of an embodiment of the disclosure, and such term is used in preference to the more restrictive term “is” so as to avoid any implication that other, compatible materials, structures, features, and methods usable in combination therewith should or must be excluded.

As used herein, the term “configured” refers to a size, shape, material composition, and arrangement of one or more of at least one structure and at least one apparatus facilitating operation of one or more of the structure and the apparatus in a predetermined way.

As used herein, the singular forms following “a,” “an,” and “the” are intended to include the plural forms as well, unless the context clearly indicates otherwise.

As used herein, the term “and/or” includes any and all combinations of one or more of the associated listed items.

As used herein, spatially relative terms, such as “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the figures. Unless otherwise specified, the spatially relative terms are intended to encompass different orientations of the materials in addition to the orientation depicted in the figures.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter).

From reading the following description it should be understood that the terms “longitudinal” and “transverse” are made in relation to the combine harvester's normal direction of travel. In other words, the term “longitudinal” equates to the fore-and-aft direction, whereas the term “transverse” equates to the crosswise direction, or left and right. Furthermore, the terms “axial” and “radial” are made in relation to a rotating body such as a shaft, wherein axial relates to a direction along the rotation axis and radial equates to a direction perpendicular to the rotation axis.

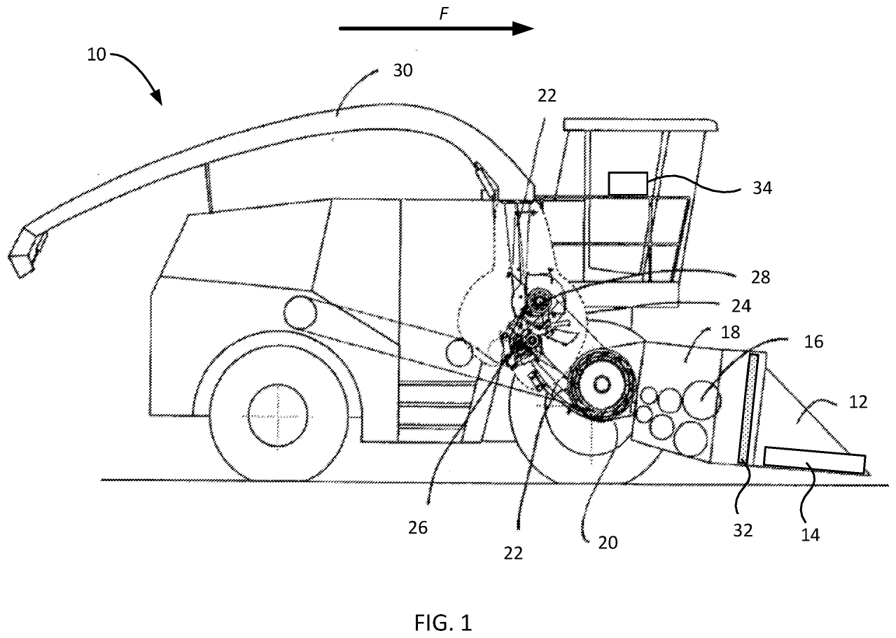

FIG. 1 shows a simplified side view of forage harvester 10 being driven in a forward direction F. The forage harvester has a header frame 12 carrying at least one cutting tool 14 for cutting a crop. The cut crop is fed through a series of compression rollers 16 in a compression roller housing 18 to a chopper drum 20, where the crop is chopped into smaller pieces. The chopped crop passes through a duct 22 and is fed through a cracker unit 24, where the crop is further crushed and threshed by cracker rollers 26. The harvested crop is then blown upwards along duct 22 by an accelerator 28 and exits through a spout 30. Typically, the spout 30 may direct the crop to a cart pulled by a tractor near the forage harvester 10.

The header frame 12 may have a shape to direct cut crop material from the cutting tool 14 toward the compression rollers 16, and may optionally include additional equipment such as belts, rollers, shafts, etc. The header frame 12 may have a sensor array 32 arranged around a volume through which the cut crop material passes en route to the cracker unit 24, such as before the compression rollers 16.

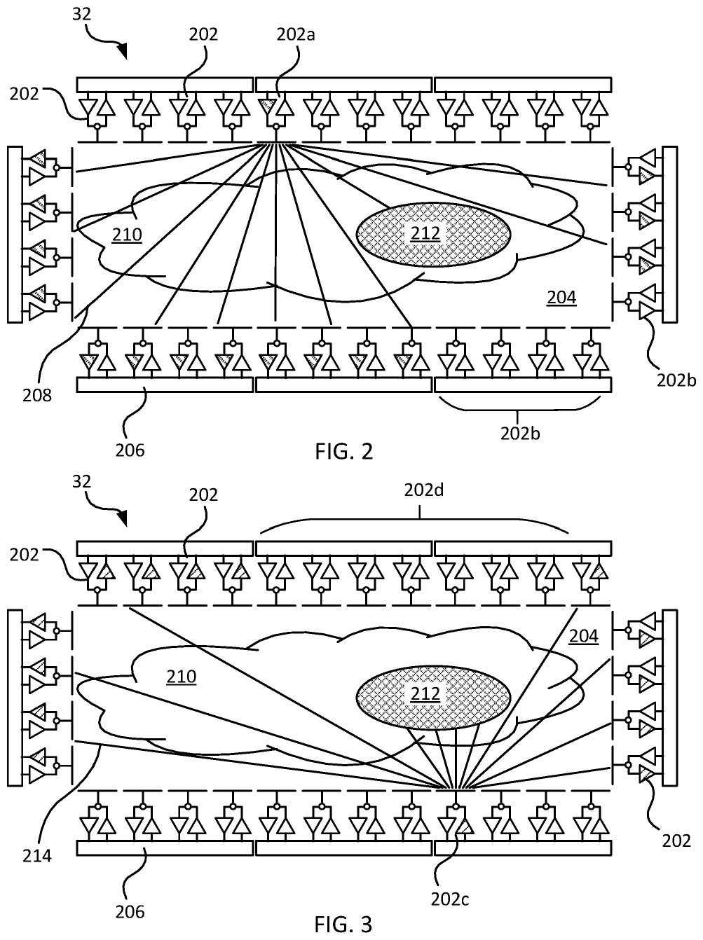

FIGS. 2 and 3 are simplified diagrams illustrating how the sensor array 32 may be used to detect and analyze the cut crop material. The sensor array 32 may include a plurality of electrodes 202 arranged around a periphery of a sensing area 204. The electrodes 202 may each be configured to transmit and receive electromagnetic energy. The electrodes 202 may be a part of individual integrated circuits 206. For example, the integrated circuits 206 shown in FIGS. 2 and 3 each include four electrodes 202. The sensor array 32 shown includes eight integrated circuits 206 around the sensing area 204. For example, integrated circuits 206 carrying electrodes 202 may be located adjacent each of four sides of the sensing area 204. The integrated circuits 206 may include more or fewer electrodes 202 than shown, and the sensor array 32 may include more or fewer integrated circuits 206 than shown, as may be selected based on design considerations such as space, cost, case of manufacture, etc. Individual integrated circuits 206 may be more easily replaced than individual electrodes 202 in case of a failure, and replacement of the integrated circuits 206 may be cheaper than replacement of the entire sensor array 32.

Typically, one electrode 202 may generate a first electromagnetic field by broadcasting electromagnetic radiation, indicated in FIG. 2 by field lines 208 within the sensing area 204 emanating from electrode 202a. Other electrodes 202, typically those oriented perpendicular to the electrode 202a and those on the opposite side of the sensing area 204, may detect the electromagnetic radiation. In some embodiments, the electromagnetic radiation may pass through crop material 210 relatively unchanged. The electromagnetic radiation may be attenuated by objects 212 such as rocks, metal, etc. Thus, the electromagnetic radiation may not be detected at some of the electrodes 202, particularly electrodes 202b in FIG. 2.

In some embodiments, another electrode 202 may generate a second electromagnetic field by broadcasting electromagnetic radiation, indicated in FIG. 3 by field lines 214 within the sensing area 204 emanating from electrode 202c. Other electrodes 202 may detect the electromagnetic radiation. The electromagnetic radiation may not be detected at some of the electrodes 202, particularly electrodes 202d in FIG. 3. The electrodes 202 that are not transmitting (and that are in view of the transmitting electrode 202) may measure an attribute of the electromagnetic fields, such as attenuation of electromagnetic energy, intensity of the radiation received, frequency of the radiation, etc.

In some embodiments, the first electromagnetic field (FIG. 2) may be formed by electromagnetic radiation from the electrode 202a having a first wavelength, and the second electromagnetic field (FIG. 3) may be formed by waves electromagnetic radiation from the electrode 202c having a second wavelength different than the first wavelength. In other embodiments, both fields may be formed by electromagnetic radiation having the same wavelength. The electrodes 202 may be selected to transmit and receive at any selected wavelength, such as from about 1 millimeter to about 300 millimeters, from about 0.5 millimeters to about 5 millimeters, or any other selected range. Typically, relatively shorter wavelengths may be better able to detect relatively smaller objects, but other factors may play a role in the selection of wavelength (e.g., power requirements, cost, electrode size, etc.). Furthermore, the wavelength(s) may be selected such that harvested crop material has a different effect on the electromagnetic fields in the sensing area 204 than typical foreign objects 212 that would be expected to be present. For example wavelengths may be selected at which cut crop material (e.g., maize) is nearly transparent (i.e., low attenuation), but at which metallic material is opaque (i.e., near total attenuation). For example, microwave radiation is reflected by metals, but is transmitted with some attenuation through water and organic material.

Though only two different electromagnetic fields are depicted in FIGS. 2 and 3, each of the electrodes 202 could be used to generate separate electromagnetic fields at different times. Thus, the number of different electromagnetic fields that may be generated in the sensing area 204 may be equal to the number of electrodes 202. Because the sensor array 32 can generate multiple different electromagnetic fields, the sensor array may be capable of detecting the presence, size, and location of the objects 212 within the sensing area 204 by correlating attributes of the electromagnetic fields to a property of the material in the sensing area 204. In some embodiments, computational tomography may be used to characterize objects 212 in the sensing area 204.

For example, when the electrodes 202a, 202c are transmitting (broadcasting), the radiation may be blocked by the object 212, and thus the electrodes 202b, 202d on an opposite side may measure a weaker (e.g., at least 90% weaker, at least 95% weaker, at least 99% weaker, or at least 99.5% weaker) radiation than other electrodes 202 of the sensor array 32.

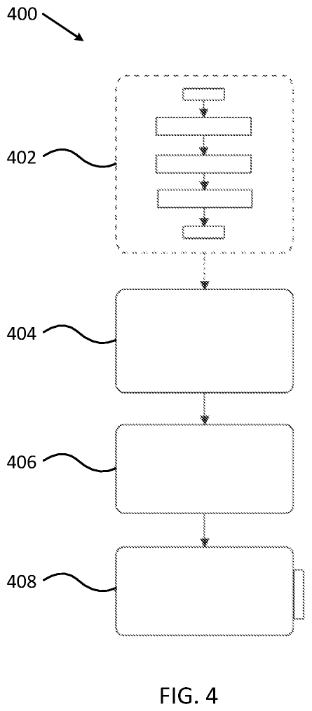

The forage harvester 10 may have a controller 34 configured to control operating parameters of the forage harvester 10 (e.g., ground speed, direction, roller speed, etc. The controller 34 may also be configured to cause selected electrodes 202 to transmit electromagnetic energy and others to measure electromagnetic energy. The controller 34 may include a computer-readable storage medium (e.g., a non-transitory computer-readable storage medium) having processor-executable instructions configured to implement techniques to detect objects 212. An example computer-readable medium that may be devised is illustrated in FIG. 4, wherein an implementation 400 includes a computer-readable storage medium 402 (e.g., a flash drive, CD-R, DVD-R, application-specific integrated circuit (ASIC), field-programmable gate array (FPGA), a platter of a hard disk drive, etc.), on which is computer-readable data 404. This computer-readable data 404 in turn includes a set of processor-executable instructions 406 configured to operate according to one or more of the principles set forth herein. In some embodiments, the processor-executable instructions 406 may be configured to cause the controller 34 to perform operations 408 when executed via a processing unit, such as comparing electromagnetic energy detected by one electrode 202 to that detected by other electrodes 202. Many such computer-readable media may be devised by those of ordinary skill in the art that are configured to operate in accordance with one or more of the techniques presented herein.

The electrodes 202 may each be arranged in a plane approximately perpendicular to a direction of travel of the cut crop material in the header frame 12, such that the cut crop material passes through the plane. Thus, the sensor array 32 may measure properties of any material (i.e., crop material or any foreign object) passing from the header frame 12 to the compression rollers 16, chopper drum 20, and cracker unit 24. When a foreign object is detected as commingled with the crop material, the controller 34 may stop operation so that the foreign object does not damage the forage harvester 10. An operator may then remove the foreign object and restart the harvesting operation.

The sensor array 32 in conjunction with the controller 34 may detect foreign objects (e.g., rocks, metal, posts, etc.) having a minimum dimension (e.g., a width or length) greater than the wavelength at which the electrodes 202 transmit. For example, an electrode 202 transmitting at a wavelength of 3 mm may enable the controller 34 to reliably identify objects having a diameter of at least about 5 mm. The detection efficiency (i.e., percent of objects identified) may also be affected by material flow rates, sampling rates, power levels, or other design considerations.

Though shown and described in a forage harvester 10, the sensor array 32 may be used with any harvesting machine, such as a combine harvester, a windrower, a baler, etc. The sensor array 32 may be a part of a harvesting header, or as part of another machine. For example, the sensor array 32 may be configured as part of a feederhouse of a combine harvester. Combine harvesters are described generally in U.S. Pat. No. 10,342,179, “Material Conveyance System in a Combine Harvester,” granted Jul. 9, 2019.

Additional non-limiting example embodiments of the disclosure are described below.

Embodiment 1: A method of detecting foreign objects in crop material, the method comprising transferring a crop material through a sensing area, wherein a plurality of electrodes are arranged around a periphery of the sensing area. A first electromagnetic field is generated by broadcasting first electromagnetic radiation from a first electrode of the plurality into the sensing area. A first attribute is measured related to the first electromagnetic field at some of the plurality of electrodes. A second electromagnetic field is generated by broadcasting second electromagnetic radiation from a second electrode of the plurality into the sensing area. A second attribute is measured related to the second electromagnetic field at some of the plurality of electrodes. The first and second attributes are correlated to a property of a material in the sensing area.

Embodiment 2: The method of Embodiment 1, wherein the first attribute comprises an attenuation of the first electromagnetic radiation, and wherein the second attribute comprises attenuation of the second electromagnetic radiation.

Embodiment 3: The method of Embodiment 1 or Embodiment 2, wherein measuring the first attribute comprises measuring an intensity of the first electromagnetic radiation, and wherein measuring the second attribute comprises measuring an intensity of the second electromagnetic radiation.

Embodiment 4: The method of any one of Embodiment 1 through Embodiment 3, wherein measuring the first attribute comprises measuring an intensity of the first electromagnetic radiation received by at least one electrode oriented perpendicular to the first electrode, and wherein measuring the second attribute comprises measuring an intensity of the second electromagnetic radiation received by at least one electrode oriented perpendicular to the second electrode.

Embodiment 5: The method of any one of Embodiment 1 through Embodiment 4, further comprising identifying non-crop material commingled with the crop material passing through the sensing area.

Embodiment 6: The method of Embodiment 5, wherein identifying non-crop material comprises identifying rocks.

Embodiment 7: The method of Embodiment 5 or Embodiment 6, wherein identifying non-crop material comprises identifying metal objects.

Embodiment 8: The method of any one of Embodiment 5 through Embodiment 7, wherein identifying non-crop material comprises identifying objects having a minimum dimension greater than a wavelength of the first electromagnetic radiation and a wavelength of the second electromagnetic radiation.

Embodiment 9: The method of any one of Embodiment 1 through Embodiment 8, wherein a wavelength of the first electromagnetic radiation is the same as a wavelength of the second electromagnetic radiation.

Embodiment 10: The method of any one of Embodiment 1 through Embodiment 9, wherein a wavelength of the first electromagnetic radiation is different from a wavelength of the second electromagnetic radiation.

Embodiment 11: The method of any one of Embodiment 1 through Embodiment 10, further comprising cutting the crop material with a harvesting header.

Embodiment 12: The method of Embodiment 11, wherein cutting a crop material with a harvesting header comprises carrying the harvesting header on a forage harvester or a combine harvester.

Embodiment 13: A harvesting header, comprising at least one cutting tool, a header frame carrying the at least one cutting tool, and a controller. The header frame is configured to transport cut crop material from the at least one cutting tool through a sensing area to a machine carrying the harvesting header. A plurality of electrodes are arranged around a periphery of the sensing area. The controller is configured to cause individual electrodes of the plurality to generate electromagnetic fields by broadcasting electromagnetic radiation into the sensing area and measure an attribute related to the electromagnetic fields at some of the plurality of electrodes.

Embodiment 14: The harvesting header of Embodiment 13, wherein the controller is configured to correlate the attribute to a property of a material in the sensing area.

Embodiment 15: The harvesting header of Embodiment 13 or Embodiment 14, wherein each of the electrodes are configured to broadcast microwave radiation.

Embodiment 16: The harvesting header of Embodiment 15, wherein each of the electrodes are configured to broadcast microwave radiation having a wavelength between 1 millimeter and 1 meter.

Embodiment 17: The harvesting header of any one of Embodiment 13 through Embodiment 16, wherein the controller is configured to cause only one electrode at a time to broadcast an electromagnetic field into the sensing area while other of the plurality of electrodes receive the electromagnetic field.

Embodiment 18: The harvesting header of any one of Embodiment 13 through Embodiment 17, wherein the plurality of electrodes are arranged in a plane approximately perpendicular to a direction of transport of the cut crop material in the harvesting header.

Embodiment 19: The harvesting header of any one of Embodiment 13 through Embodiment 18, wherein the plurality of electrodes are arranged such that at least one electrode is adjacent each of four sides of the sensing area.

Embodiment 20: An agricultural machine comprising a frame configured to transport cut crop material from at least one cutting tool through a sensing area to a crop-processing device, a plurality of electrodes arranged around a periphery of the sensing area, and a controller. The controller is configured to cause individual electrodes of the plurality to generate electromagnetic fields by broadcasting electromagnetic radiation into the sensing area and measure an attribute related to the electromagnetic fields at some of the plurality of electrodes.

Embodiment 21: The agricultural machine of Embodiment 20, wherein the controller is configured to detect a foreign object in the cut crop material based on the attribute related to the electromagnetic fields.

Embodiment 22: The agricultural machine of Embodiment 21, wherein the controller is further configured to stop operation of the crop-processing device after detecting the foreign object.

Embodiment 23: The agricultural machine of any one of Embodiment 20 through Embodiment 22, wherein the agricultural machine comprises a forage harvester or a combine harvester.

Embodiment 24: The agricultural machine of any one of Embodiment 20 through Embodiment 23, wherein the plurality of electrodes are arranged such that at least one electrode is adjacent each of four sides of the sensing area.

All references cited herein are incorporated herein in their entireties. If there is a conflict between definitions herein and in an incorporated reference, the definition herein shall control.

While the present invention has been described herein with respect to certain illustrated embodiments, those of ordinary skill in the art will recognize and appreciate that it is not so limited. Rather, many additions, deletions, and modifications to the illustrated embodiments may be made without departing from the scope of the invention as hereinafter claimed, including legal equivalents thereof. In addition, features from one embodiment may be combined with features of another embodiment while still being encompassed within the scope of the invention as contemplated by the inventors. Further, embodiments of the disclosure have utility with different and various machine and sensor types and configurations.

1. A method of detecting foreign objects in crop material, the method comprising:
transferring a crop material through a sensing area, wherein a plurality of electrodes are arranged around a periphery of the sensing area;
generating a first electromagnetic field by broadcasting first electromagnetic radiation from a first electrode of the plurality into the sensing area;
measuring a first attribute related to the first electromagnetic field at some of the plurality of electrodes;
generating a second electromagnetic field by broadcasting second electromagnetic radiation from a second electrode of the plurality into the sensing area;
measuring a second attribute related to the second electromagnetic field at some of the plurality of electrodes; and
correlating the first and second attributes to a property of a material in the sensing area.

2. The method of claim 1, wherein the first attribute comprises an attenuation of the first electromagnetic radiation, and wherein the second attribute comprises attenuation of the second electromagnetic radiation.

3. The method of claim 1, wherein measuring the first attribute comprises measuring an intensity of the first electromagnetic radiation, and wherein measuring the second attribute comprises measuring an intensity of the second electromagnetic radiation.

4. The method of claim 1, wherein measuring the first attribute comprises measuring an intensity of the first electromagnetic radiation received by at least one electrode oriented perpendicular to the first electrode, and wherein measuring the second attribute comprises measuring an intensity of the second electromagnetic radiation received by at least one electrode oriented perpendicular to the second electrode.

5. The method of claim 1, further comprising identifying non-crop material commingled with the crop material passing through the sensing area.

6. The method of claim 5, wherein identifying non-crop material comprises identifying rocks or metal objects.

7. (canceled)

8. The method of claim 5, wherein identifying non-crop material comprises identifying objects having a minimum dimension greater than a wavelength of the first electromagnetic radiation and a wavelength of the second electromagnetic radiation.

9. The method of claim 1, wherein a wavelength of the first electromagnetic radiation is the same as a wavelength of the second electromagnetic radiation.

10. The method of claim 1, wherein a wavelength of the first electromagnetic radiation is different from a wavelength of the second electromagnetic radiation.

11-12. (canceled)

13. A harvesting header, comprising:
at least one cutting tool;
a header frame carrying the at least one cutting tool, wherein the header frame is configured to transport cut crop material from the at least one cutting tool through a sensing area to a machine carrying the harvesting header;
a plurality of electrodes arranged around a periphery of the sensing area; and
a controller configured to:
cause individual electrodes of the plurality to generate electromagnetic fields by broadcasting electromagnetic radiation into the sensing area; and
measure an attribute related to the electromagnetic fields at some of the plurality of electrodes.

14. The harvesting header of claim 13, wherein the controller is configured to correlate the attribute to a property of a material in the sensing area.

15. The harvesting header of claim 13, wherein each of the electrodes are configured to broadcast microwave radiation.

16. (canceled)

17. The harvesting header of claim 13, wherein the controller is configured to cause only one electrode at a time to broadcast an electromagnetic field into the sensing area while other of the plurality of electrodes receive the electromagnetic field.

18. The harvesting header of claim 13, wherein the plurality of electrodes are arranged in a plane approximately perpendicular to a direction of transport of the cut crop material in the harvesting header.

19. The harvesting header of claim 13, wherein the plurality of electrodes are arranged such that at least one electrode is adjacent each of four sides of the sensing area.

20. An agricultural machine, comprising:
a frame configured to transport cut crop material from at least one cutting tool through a sensing area to a crop-processing device;
a plurality of electrodes arranged around a periphery of the sensing area; and
a controller configured to:
cause individual electrodes of the plurality to generate electromagnetic fields by broadcasting electromagnetic radiation into the sensing area; and
measure an attribute related to the electromagnetic fields at some of the plurality of electrodes.

21. The agricultural machine of claim 20, wherein the controller is configured to detect a foreign object in the cut crop material based on the attribute related to the electromagnetic fields.

22. The agricultural machine of claim 21, wherein the controller is further configured to stop operation of the crop-processing device after detecting the foreign object.

23. The agricultural machine of claim 20, wherein the agricultural machine comprises a forage harvester or a combine harvester.

24. The agricultural machine of claim 20, wherein the plurality of electrodes are arranged such that at least one electrode is adjacent each of four sides of the sensing area.
